(19) United States
(12) Patent Application Publication
(10) Pub. No.: US 2013/0335336 A1
(43) Pub. Date: Dec. 19, 2013

(54) INTERACTIVE LOBBY PARTITION

(71) Applicants: Ryan Esparza, Atlanta, GA (US); Mark Greenhalgh, Atlanta, GA (US); Andrew Hairetis, Sandy Springs, GA (US); Dennis Lackey, Roswell, GA (US); Eric Nicolas, Marietta, GA (US)

(72) Inventors: Ryan Esparza, Atlanta, GA (US); Mark Greenhalgh, Atlanta, GA (US); Andrew Hairetis, Sandy Springs, GA (US); Dennis Lackey, Roswell, GA (US); Eric Nicolas, Marietta, GA (US)

(73) Assignee: Six Continents Hotels, Inc., Atlanta, GA (US)

(21) Appl. No.: 13/495,913

(22) Filed: Jun. 13, 2012

(51) Int. Cl. G06F 3/041

(52) U.S. Cl. CPC G06F 3/041
USPC 345/173

(57) ABSTRACT

An interactive lobby partition may be used to provide interactive information to users and/or to provide area or module integration within a larger space. The partition may include a first side with an interactive display device and/or digital travel information. The partition may also include a second side with a media center or cabinet for supporting and/or presenting media items. In some aspects, the partition may be placed between a media lounge and an elevator lobby. The partition may be placed such that the interactive display devices and/or digital travel information may be facing an elevator lobby or elevator waiting area. Further, the partition may also be placed such that the media cabinet or media center may be facing a media lounge with couches, chairs, and/or tables configured for consuming the media available via the media cabinet.

### BACKGROUND

Many hotels provide separate and distinct public spaces for customers and/or guests to utilize while traveling. For example, some hotels may have a lobby, a café, and/or a business center. However, in some instances, customers and/or guests may request amenities from one space (e.g., a computer with an Internet connection) while they are physically located in a different space of the hotel (e.g., the lobby, the café, etc.). This may, in some cases, cause unnecessary discomfort to the guests and they make seek certain amenities elsewhere. As such, finding improved ways for hotels to integrate public spaces continues to be a priority.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a top view of one example hotel space. Here, multiple public spaces are separated by one or more partitions to create an open floor plan space for customers and/or guests of the hotel.

FIG. 2 illustrates a first view of an example interactive lobby partition for providing interactive travel information and services, media consumption, and/or for integrating areas within the hotel space to create an open floor plan.

FIG. 3 illustrates a second view of the example interactive lobby partition shown in FIG. 2, also for interactive travel information and services, media consumption, and/or for integrating areas within the hotel space to create an open floor plan.

### DETAILED DESCRIPTION

### Overview

Embodiments of the present disclosure are directed to, among other things, providing an interactive lobby partition for a public space within a merchant or other establishment such as, but not limited to, a hotel, a restaurant, an Internet café, a coffee shop, a lounge, combinations of the foregoing, or the like. As an overview, a public space may be any interior or exterior space within a public or private facility including, but not limited to, a home, a business, a library, a park, etc., where people can gather and/or interact with one another. For example, a public space may include a lobby, a restaurant, a lounge, a waiting area, or a business center (e.g., a computer terminal and/or printing station) within a private hotel. In some examples, the public spaces may be part of an open floor plan-style design, whereby half-walls, partitions, and/or other spaces (e.g., as opposed to full walls and/or doors) may be utilized to separate each individual area. That is, in some cases, the public spaces may be more fully integrated with one another to provide a single cohesive space to help customers and/or guests enjoy a variety of experiences without leaving the single space.

In some aspects, a guest services module or front desk area may be utilized by a hotel to provide live help, guidance, and/or reservation services for checking in, checking out, and/or reserving rooms at one or more establishments. The guest services module may provide live support in the form of one or more hotel employees. Additionally, a media lounge may be provided for guests to gather, relax, and/or consume media. In some aspects, media may include television programs, movies, music, sporting events, news, print media (e.g., newspapers, magazines, books, etc.), or the like. As such, a media lounge may provide a space for consuming the media as well as a place for storing and/or displaying the media. For example, a media lounge may include a media cabinet, entertainment stand, or other supporting device for a television, monitor, other digital media components (e.g., a cable converter, a TV tuner, a satellite converter, a digital video recorder (DVR), a compact disc (CD) player, a digital video disc (DVD) player, an amplifier, a radio tuner, etc.), books, magazines, newspapers, or like. The media lounge may also include, in some examples, chairs, couches, chaise lounges, stools, benches, etc., for seating, relaxing, and/or enjoying the media found within or presented upon the media lounge. Further, in some examples, an elevator lobby may be a space adjacent to, or directly in front of, one or more elevator doors. As such, an elevator lobby may be a convenient place for guests to wait for and/or exit an elevator that services the hotel.

In some aspects, an interactive lobby partition may be utilized to separate a media lounge and an elevator lobby. That is, in some examples, a wall, a divider, or a free-standing partition (e.g., a wall that does not extend to the ceiling of the room) may be provided at the entrance/exit of a bay of elevators (i.e., the elevator lobby) such that one side faces the elevator lobby and/or elevator doors while the other side faces the media lounge. Further, in some cases, the side of the partition facing the media lounge may include a media cabinet such as, but not limited to, the cabinet described above, while the side of the partition facing the elevator lobby may include an interactive check-in/check-out station. In some examples, such a station (or computer system) may include, but is not limited to, a flight status monitor, a display device, a computing device, and/or a printing device. Further, in some examples, a computing device and display may be integrated into a single device, such as with a touch-screen. In this way, hotel customers and/or guests may utilize the computing device by interacting with the touch-screen device without the need for additional input/output (I/O) peripherals. However, in some examples, a mouse, a keyboard, a printer, and/or other devices may be coupled to the computing device to aid in checking in, checking out, viewing travel reservations, and/or making travel reservations. The interactive check-in/check-out station may also be integrated with, or otherwise adjacent to, the media cabinet in some cases. For example, the check-in station may be included in one portion of the media cabinet and/or media cabinet features may be included on the same side of the partition as the check-in station.

In some aspects, an interactive lobby partition may also provide integration between one or more hotel public areas without creating disjunction between the spaces. That is, in some examples, as noted above, the partition may be configured as a free-standing wall that does not reach the ceiling of the media lounge and/or the elevator lobby. In this way, a customer and/or guest may feel as if they are part of the entire public space, including the other portions of the hotel (e.g., outside of the media lounge and/or elevator lobby) without leaving the elevator lobby or the media lounge. Further, the free-standing nature of the partition may enable the open floor plan design of the hotel lobby as in a loft apartment, or the like. Providing this open floor plan, in some examples, may integrate several different areas of the hotel into a single public space (e.g., where one can check-in, check-out, view travel information and/or reservations, relax in a media lounge, order food and/or drinks, meet with others, etc., without leaving the hotel space).

This brief introduction, including section titles and corresponding summaries, is provided for the reader's convenience and is not intended to limit the scope of the claims, nor the preceding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

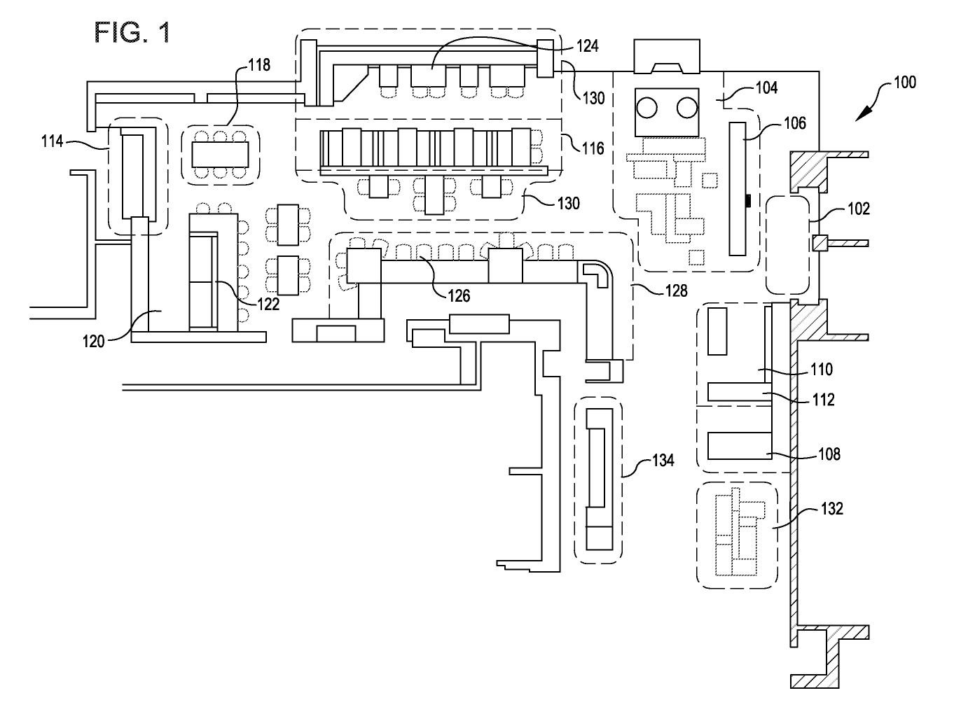

FIG. 1 depicts an illustrative top view of one example hotel space 100. Here, multiple public spaces may be separated by one or more partitions, areas, and/or other dividers to create an open floor plan space within the hotel. For example, an elevator lobby 102 may be separated from a media lounge 104 by a partition 106 (e.g., a free-standing wall). Similarly, a business center or business facility (e.g., an Internet café or an electronic-bar (E-bar)) 108 may be separated from a market (e.g., a storefront or other merchant facility) 110 by a partition 112. Alternatively, or in addition, in some examples, a first space may be separated from a second space by a third space, without a dedicated partition. For example, a chef station (e.g., a short-order cooking station) 114 may be separated from a booth seating area 116 (e.g., for eating food from the chef station 114) by a hot table 118 (e.g., a table dedicated to warm food products that may include one or more heating elements). As desired, other configurations are also possible.

In some aspects, the hotel space 100 may also include a video game area 120 dedicated to playing video games and/or a cold table 122 for providing food items. The video game area 120 and the cold table 122 may, in some examples, be separated by a waist-high partition such that guests using the cold table 122 may be able to see the video game area 120. Additionally, the cold table 122 may include a refrigeration component and/or an enclosure configured to hold ice near cold food items (e.g., milk, cream, yogurt, etc.). Additionally, in some example configurations, the hotel space 100 may include a banquet seating area 124, a bar 126, a “grab and go” or “to go,” cafeteria-style café 128 for selling food, snacks, drinks, etc., a high top seating area 130, and/or a lobby lounge 132. As noted above, each of these spaces, modules, stations, or areas may be integrated into an open floor plan via the use of partitions and/or other areas such as, but not limited to, partitions such as the interactive lobby partition 106 and/or the seating areas 116 and 130. However, in other examples, the absence of any partition may lend to the afore-mentioned open floor plan and/or integration.

In particular, the market 110 may be configured to sell one or more pre-packaged items such as, but not limited to, packaged soda, bottled water, chips, candy, gum, snacks, over-the-counter medications, or the like. Additionally, in some cases, the market 110 may be open 24 hours and/or may be unmanned, in that customers may be expected to take items to be purchased to the guest services counter 134 (e.g., the front desk) and/or the café counter 128, where live employees may be more regularly available. As such, the market 110 may be placed adjacent to or at least proximate to the front desk 134 and/or the café counter 128. Additionally, in some aspects, the bar 126 may be adjacent to and/or connected to the café 128. In this way, the space behind the counters of the bar 126 and the café 128 may be connected so that hotel employees, bartenders, and/or café staff can freely and easily maneuver between the bar 126 and the café 128. The bar 126/café 128 space may also be configured such that one is perpendicular to the other, forming an “L,” shaped counter. Further, in some aspects, the café 128 may be equipped with a digital chalkboard menu configured to display menu items and/or prices in a predefined, and/or consistent, font as if hand-written in chalk.

In some aspects, and as shown in FIG. 1, the market 110 may be directly across a hallway from the café 128. By way of example only, the E-bar 108 may be adjacent the market 110. More particularly, the E-bar 108 may also be partitioned from the market 110 by a free-standing wall. However, in some examples, a back wall of the market 110 may act as the partition. The E-bar 108 may include one or more computing devices, printers, display devices, and/or input devices. Additionally, the E-bar may include a flight status board for displaying flight information associated with one or more nearby airports. The flight status board may be a digital and/or flat-screen display device mounted to the wall of the E-bar 108. As such, customers and/or guests may utilize the E-bar 108 to check travel information such as flight status, rental car reservations, hotel reservations, or the like. Adjacent to the E-bar 108 may be a lobby lounge 132. The lobby lounge 132 may be configured with chairs, couches, etc., for customers and/or guests waiting on the guest services counter (i.e., the front desk) 134. In some configurations, the front desk 134 may be opposite the hallway from the lobby lounge 132 and/or the E-bar 108.

In some configurations, as noted above, the bar 126 may be perpendicular to the café counter 128. In this configuration, the open space adjacent to the bar 126 may be more suitable for eating/drinking/socializing than the lobby lounge 132 area. As such, several seating areas including, but not limited to, the high top seating area 130, the booth seating area 116, and/or the banquet seating area 124 may be adjacent to the bar 126 as well as the hot table 118, the cold table 122, and/or the chef station 114. Further, the chef station 114 may be regularly, or intermittently, staffed with one or more chefs for preparing individualized food orders (e.g., omelets, burgers, salads, etc.). Additionally, the hotel space 100 may be configured in such a way that nearly all areas, modules, and/or spaces are visible from one another, creating an open feeling to customers and guests. The ability to roam freely between areas and maintain perspective of each area may add to the overall integration of the hotel space 100.

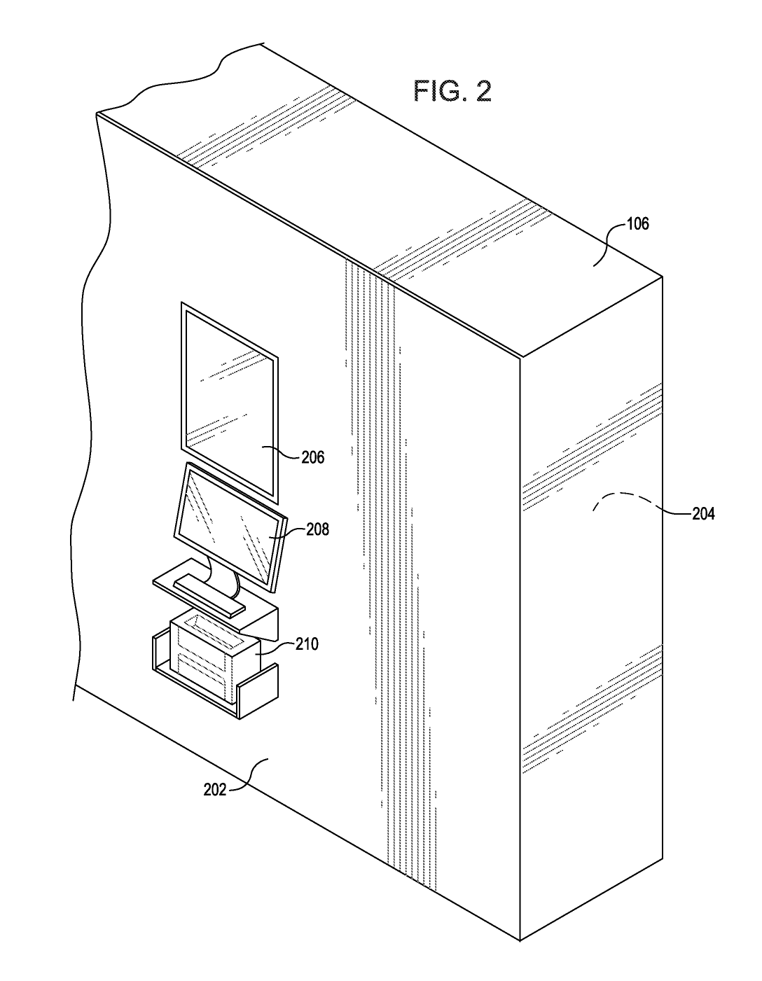

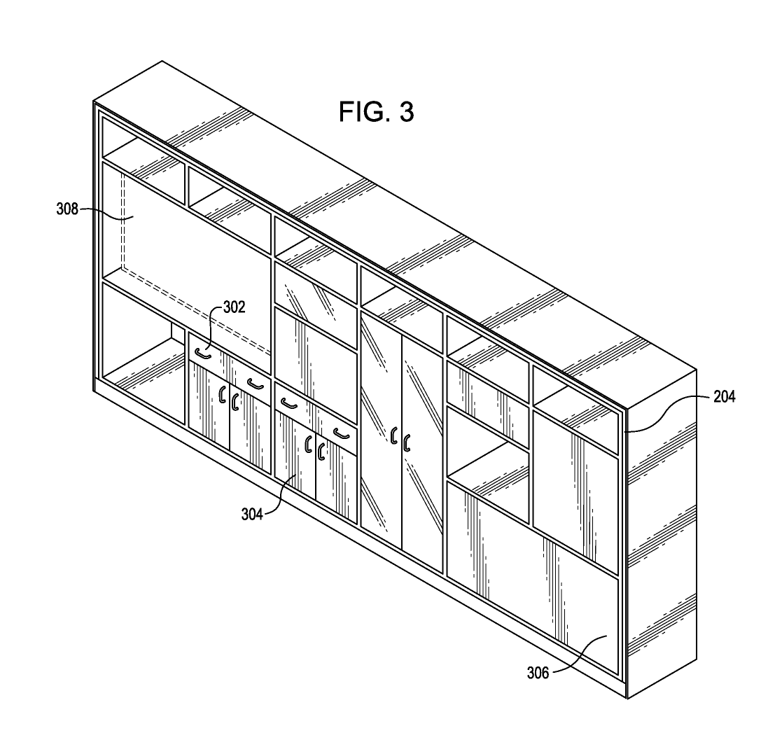

In some examples, as noted above, an elevator lobby 102 may be separated from a media lounge 104 by a partition 106. In this way, the media lounge 104 may be visible from, and an integrated portion of, the overall hotel space 100, while the elevator lobby 102 may only be visible from the market 110, café 128, front desk 134, and/or other areas that are not blocked by the partition 106. Regardless of the actual configuration, however, the partition 106 may be interactive and, thus, serve a dual purpose. On a first side, the side facing the media lounge 104 and shown in FIG. 3, the partition 106 may include a media cabinet for housing or otherwise supporting media components such as, but not limited to, a video display, a background for a projector display, a DVR, a DVD player, a CD player, an mp3 player, books, newspapers, magazines, etc. The media lounge 104 may also include couches, sofas, chairs, or the like for supporting the consumption of the media housed or otherwise supported by the interactive partition 106. Additionally, on a second side, the side facing the elevator lobby 102 and shown in FIG. 2, the partition 106 may include a flight status monitor and/or interactive I/O components (e.g., a touch screen display device, a printer, etc.) for checking in, checking out, and/or confirming, making, printing, and/or canceling reservations. In this way, guests and/or customers may utilize functionality generally available via the E-bar 108 while on their way in and/or out of the hotel space 100 or the elevator lobby 102. The media lounge, in some examples, may also include a fireplace and/or a fireplace viewing area. The fireplace may be configured as a wood burning, a gas, a facade (e.g., a still picture of a fire), and/or a digital display fireplace.

As desired, other configurations for the hotel space 100 and/or the interactive lobby partition 106 may be possible. For example, the flight status monitor and/or other I/O components may be on either side of the partition 106 and/or on multiple sides of the partition (e.g., on the elevator lobby 102 side, the media lounge 104 side, a side that is adjacent to the elevator lobby 102 or the media lounge 104, but does not include either, or any combination thereof). Similarly, media cabinet components and/or shelving may also be located on any side of the partition 106. Additionally, while the hotel space 100 is shown in FIG. 1 having a bar counter 126 that is perpendicular to a café counter 128, these two counters may not actually be perpendicular. For example, they may be in a straight line, they may make a non-perpendicular angle, or they may not even be connected to each other. Further, one or more of the seating areas 116, 124, 130 may be omitted and/or one or more partitions may actually not be free standing (i.e., they may reach the ceiling of the room or area in which they reside) without departing from the spirit and meaning of the disclosure. As such, the hotel space 100 may include modules, systems, and/or other areas that are not shown in FIG. 1

### Illustrative Partitions

FIG. 2 depicts an illustrative first view of an interactive lobby partition 106 with which area separation, hotel lobby integration, and/or interactive check-in/check-out assistance may be implemented. As noted above, in some instances, the interactive lobby partition 106 may be a free-standing wall that separates an elevator lobby and a media lounge, such as the elevator lobby 102 and/or the media lounge 104 of FIG. 1. However, in other examples, the interactive lobby partition 106 may be used to separate different portions of any public or private space, may not be free standing (i.e., may connect to other walls and/or may reach the ceiling), and/or may not be interactive. Further, in at least one example, a first side 202 of the interactive lobby partition 106 may face or be otherwise viewable from the elevator lobby 102. In other words, while exiting an elevator of the hotel space 100 of FIG. 1, a customer and/or guest may be directly or indirectly facing the first side 202 of the interactive lobby partition 106.

In at least one aspect, the interactive lobby partition 106 may include the first side 202 (in some examples, a vertical wall portion that may connect to other vertical wall portions to form a partition), noted above, and a second side 204 (also, in some examples, being vertical). Additionally, the partition 106 may also include third and fourth sides for connecting the first side 202 and the second side 204, as well as a top side (e.g., when the partition 106 is free-standing). Additionally, the inside of the partition 106 may be configured to house one or more computing devices, wires, network connections, components, peripherals, and/or mounting devices. The computing devices may be configured with one or more memory storage devices for storing computer-executable instructions and one or more processors for executing the stored computer-executable instructions. When executed, the instructions may configure the processors to receive input from users, communicate with other computing devices (e.g., servers, server farms, remote storage devices, websites, etc.) over one or more networks, and/or display travel information. As shown, in FIG. 1, the first side 202 may include a first display device 206, a second display device 208, and a printing device 210. However, different configurations may be possible such as, but not limited to, a single display device, a touch-screen display device, additional display devices (i.e., more than one or two), more or less printers, and/or other interactive tools or peripherals.

In some examples, the first display device 206 may be a flat-screen monitor configured to display flight information. The information may be live and/or associated with one or more airlines, one or more airports, arriving flights, departing flights, or any combination thereof. The information may also be updated regularly so as to display the most recent flight information whenever possible. In some aspects, the monitor may be flush-mounted to (e.g., within a recessed portion of) the first side 204 of the partition 106. In this way, it may be viewable from many angles. In some examples, however, the first display device 206 may be mounted to a non-recessed portion of the first side 204 such that the mounting hardware and display device 206 protrude from the first side 204 of the partition 106. Further, in some examples, the first display device 206 may be an interactive touch-screen device for providing interactive travel information. That is, in some examples, the flight information may be displayed concurrently with an interactive portion of the screen for receiving user input and provide user specific information and/or a web browser for retrieving and/or displaying check-in information, check-out information, and/or reservation information associated with the hotel, an airline, a rental car, or the like.

In some examples, the second display device 208 may be configured to display a web browser or other user interface (UI) for user interaction. In this way, the second display device 208 may provide the interaction described briefly above. For example, a user may log in to a hotel website, an airline website, a rental car website, or the like, and/or the user may interact with one or more agencies or companies for making reservations, verifying reservations, viewing reservation information, checking in to a reservation, checking out of a reservation, or any other travel related act. In some aspects, the second display 208 may be integrated with the first display 206 such that information displayed on the second display 208 is associated with or otherwise related to the information being displayed on the first display 206. As such, one or more of the first display 206 and/or the second display 208 may be connected to one or more computing devices and/or networks (e.g., housed within the partition 106). In some examples, the second display 208 may be mounted (e.g., flush or extending from the first side 204) on the first side 204, or it may be supported by a shelf. Further, as noted above, some or all of the functionality and interaction of the second display 208 may actually be performed by the first display 206. That is, in some examples, the flight status board and the interactive display may be integrated into a single display device (e.g., the first display 206, the second display 208, or some other display).

In some examples, a printing device 210 such as, but not limited to, a laser printer, an inkjet printer, a color printer, a dot matrix printer, or the like may be supported by or otherwise mounted to the first side 204 of the partition 106. In this way, customers and/or guests may print travel information associated with the information displayed on either, or both, of the first display 206 or the second display 208. However, in other examples, the printing device 210 may be placed in another location (e.g., at the front desk 134, at the E-bar 108, or elsewhere in the hotel space 100) and may be accessed via the one or more networks utilized by the computing devices and/or the displays 206, 208. While not shown in FIG. 2, a media lounge such as, but not limited to, the media lounge 104 of FIG. 1 may be integrated with or otherwise included on the first side 202, the second side 204, and/or any other side of the partition 106.

FIG. 3 depicts an illustrative second view of the interactive lobby partition 106 with which area separation, hotel lobby integration, and/or media consumption may be implemented. As noted above, in some instances, the partition 106 may be a free-standing wall that separates an elevator lobby and a media lounge, or other areas. Further, in at least one example, and as shown in FIG. 3, the second side 204 of the partition 106 may face or be otherwise viewable from a media lounge, such as the media lounge 104 of FIG. 1. In other words, while sitting or standing in the media lounge 104, a customer and/or guest may be directly or indirectly facing the second side 204 of the interactive lobby partition 106.

In some aspects, as noted above, the second side 204 of the interactive lobby partition 106 may be configured as a media cabinet and may include one or more drawers 302, cabinets 304, shelves 306, and/or display devices 308 for displaying, supporting, or otherwise consuming media. For example, a drawer 302, a cabinet 304, or a shelf 306 may be utilized to store games, books, magazines, remote controls, manuals, local information, advertisements, digital media components (e.g., a DVR, a DVD player, a cable or satellite converter, etc.), or the like. Additionally, a shelf 306 may be utilized to support one or more display devices 308 for presenting television programs, movies, sports programs, DVR content, interactive web content, or other types of media suitable for a display device. Further, the display device 308 may also be an interactive touch-screen display device for interacting with a user and/or providing travel information. For example, the display device 308 may be coupled to the one or more computers and/or networks housed within the partition 106 and may be configured to receive touch input from a user and, in response, provide travel information associated with the flight information and/or reservations described with reference to the first display device 206 and/or the second display device 208 of FIG. 2.

In some examples, the display device 308 may be mounted to the partition 106 within the space that occupies a shelf 306. In this way, the shelf 306 may not actually support the display device 308. Further, in some examples, a shelf 306 may include one or more hanging and/or mounting devices for hanging or otherwise presenting print media for display. For example, a hanging device may be configured such that one or more newspapers may hang in such a way that the covers of multiple newspapers are legible without removing the newspaper from the hanging device. Additionally, as shown in FIG. 3, some shelf space may extend from the second side 204 to the first side 202 of the partition 106, thus creating the illusion of space and allowing a guest and/or customer to see through the partition 106 at that location. Further, while FIG. 3 is shown with a particular configuration of drawers 302, cabinets 304, and/or shelves 306, any combination of drawers 302, cabinets 304, shelves 306, display devices 308, cut-out spaces, and/or other media cabinet features may be envisioned and/or utilized to implement the interactive lobby partition 106.

The example architectures, floor plans, tools, and computing devices shown in FIGS. 1-3 are provided by way of example only. Numerous other operating environments, systems, tools, floor plans, and configurations are possible. Accordingly, embodiments of the present disclosure should not be construed as being limited to any particular environments, systems, tools, floor plans, or configurations.

What is claimed is:

1. A hotel lobby, comprising:
an elevator lobby;
a media lounge; and
a free-standing kiosk separating the media lounge and the elevator lobby, the free-standing kiosk comprising:
a first vertical wall, comprising:
a display device configured to cause display of at least one of check-in information, check-out information, or flight status information; and
a touch-screen device configured to:
cause display of second information associated with at least one of the check-in information, the check-out information, or the flight status information; and
receive input associated with the second information;
a second vertical wall, opposite the first vertical wall, comprising a media center configured to house at least one of a display device, a media item, a drawer, a shelf, or a cabinet; and
one or more additional vertical walls configured to connect the first vertical wall to the second wall.

2. The hotel lobby of claim 1, wherein the vertical walls do not reach a ceiling in the hotel lobby.

3. The hotel lobby of claim 1, wherein the first vertical wall is adjacent to and faces the elevator lobby.

4. The hotel lobby of claim 1, wherein the display device comprises a flat-screen monitor.

5. The hotel lobby of claim 1, wherein the check-in information or check-out information is associated with a hotel room, an airplane flight, or a vehicle rental.

6. The hotel lobby of claim 1, wherein the second information comprises the check-in information, the check-out information, or the flight-status information.

7. The hotel lobby of claim 1, wherein the input comprises a request to check-in, check-out, print, or make a reservation.

8. The hotel lobby of claim 1, wherein the first vertical wall further comprises a printing device configured to print information associated with a trip.

9. The hotel lobby of claim 1, wherein at least one of the display device or the touch-screen device are mounted within a recessed space such that a portion of the display device or the touch-screen device are flush with an outer surface of the first vertical wall.

10. The hotel lobby of claim 1, wherein the elevator lobby comprises a space adjacent to an elevator entrance.

11. A hotel lobby, comprising:
an elevator lobby;
a media lounge; and
a media cabinet separating the media lounge and the elevator lobby, the media cabinet comprising:
a front wall configured with at least one of a shelf or a cabinet to support at least a first display device coupled to a media signal or to support additional media items; and
a back wall configured to support at least one of a second display device coupled to a network or a touch-screen device coupled to the network, the second display device or the touch-screen device configured to cause display of information associated with at least one of check-in information, check-out information, or flight status information, and wherein the front wall faces the media lounge and the back wall faces the elevator lobby.

12. The hotel lobby of claim 11, wherein the front wall and the back wall are substantially vertical.

13. The hotel lobby of claim 11, wherein the media signal is received via the network.

14. The hotel lobby of claim 11, wherein the additional items comprise at least one of a third display device, a magazine, a newspaper, a book, or a media player.

15. The hotel lobby of claim 11, wherein at least one of the second display device or the touch-screen display device are integrated with or flush-mounted to the back wall.

16. The hotel lobby of claim 11, wherein the back wall is further configured to support a printer coupled to the network.

17. A hotel lobby system for partitioning space and providing digital information, comprising:
an elevator lobby;
a media lounge; and
a media partition separating the media lounge and the elevator lobby, comprising:
a first media wall configured to face the elevator lobby, comprising a first display device mounted therein;
a second media wall configured to face the media lounge, comprising at least one of a cabinet, a drawer, or a shelf for supporting a second display device; and
one or more side walls for enclosing a space between the first media wall and the second media wall, wherein the space is configured to house at least one of a communication connection or a power connection for the first display device and the second display device.

18. The hotel lobby system of claim 17, wherein the first display device comprises at least one of a flat screen display device, a flight status monitor, a touch-screen display device, an interactive check-in/check-out display device, or a printing device.

19. The hotel lobby system of claim 17, wherein the second display device is configured to display at least one of live television content, recorded television content, a movie, an advertisement, analog content, digital content, streaming content, digital video disc (DVD) content, or digital video recorder (DVR) content.

20. The hotel lobby system of claim 17, wherein the first media wall further comprises a printing device configured to print trip information associated with the hotel.
